(19) United States
(12) Patent Application Publication
(10) Pub. No.: US 2013/0332349 A1
(43) Pub. Date: Dec. 12, 2013

(54) ATM FOR USE WITH CASH BILL PAYMENT

(71) Applicant: Nathan Dent, Concord, NC (US)

(72) Inventor: Nathan Dent, Concord, NC (US)

(73) Assignee: Bank of America, Charlotte, NC (US)

(21) Appl. No.: 13/490,684

(22) Filed: Jun. 7, 2012

(51) Int. Cl. G06Q 20/18; G06Q 20/14

(52) U.S. Cl. 705/40

(57) ABSTRACT

A method for employing an electronic self-service apparatus that enables a payor to pay a domestic or foreign, preexisting bill or invoice, using cash, or cash in combination with at least one of, checks, and credit items, wherein any of the items may be in local or foreign currency. The method employs a processing unit and an input module for receiving data entered by the payor at the apparatus. This data input comprises, tactile, optical, voice, smart card, or pre-recorded, computer-readable media device input. It also employs a receiver module configured for receiving cash, checks, and credit items. Communication occurs between, at least two of, the payor, payee, a financial institution and the apparatus. An embodiment may include a visual display, audio output module, and a printer, and an output module for enabling the entry of information to a computer-readable media device.

### FIELD OF TECHNOLOGY

Aspects of the disclosure relate to paying pre-existing bills or invoices with cash using an automated teller machine (“ATM”).

### BACKGROUND

Many options for pre-existing bill payment are available to consumers. Some of the options involve on line banking. Some of the inventions involve in-person payment. Yet other of these options involve payment by telephone.

It would be desirable to develop and provide highly efficient pre-existing bill payment options.

It would be further desirable to provide pre-existing bill payment options that allow payment in the absence of a substantial relationship with a financial institution.

It would be yet further desirable to provide pre-existing bill payment options that allow substantially simultaneous payment of bills by a multitude of methods.

### SUMMARY

A method for employing an electronic self-service apparatus that enables a payor to pay a pre-existing bill or invoice, hereinafter referred to as a “bill”, whether the bill is of local or foreign origin, using cash, or cash in combination with at least one of, checks, and other credit items, e.g., a credit slip, a coupon, a money order, a credit card, a debit card, wherein any of the items may be in local or foreign currency. (See Table 1 for descriptions.)

TABLE 1
Description of Financial Resources

| | Type | Examples |
|---|---|---|
| Tangible | Cash | Currency |
| Financial Resources | Check | Personal, bank, government, |
| (For Deposit) | | institutional, third party |
| | Credit Item | Money order, coupon, refund |
| | | slip, credit slip, rebate |
| | | slip, transfer slip, credit |
| | | card, debit card |
| Electronic | Transfer | To, from or among payor's |
| Financial Resources | | accounts; |
| | | To, from or among accounts to |
| | | which payor has access |
| | Advance | From payor's existing loan or |
| | | line or credit; |
| | | From payor's new loan or line |
| | | of credit; |
| | | Overdraft |

The method employs a processing unit and an input module for receiving data entered by the payor at the apparatus. This data input comprises, at least one of: tactile input, optical input, voice input, pre-recorded, computer-readable media and card device input, contact, or contactless, integrated circuit card, or device input. (The latter contain a volatile memory and microprocessor components, and are known as an “ICC”, a “smart card”, a “smart ring”, hereinafter, “smart card”. Hereinafter smart cards will be included in the term card device.) The apparatus also employs a receiver module configured for receiving cash, checks, and credit items. Furthermore, it employs an item-handling mechanism for accepting cash, checks or credit items and a modem for enabling communication between, at least two of, the apparatus, the payor, a payee, a financial institution, wherein a payee comprises:
a merchant,
a vendor,
a provider of goods, services, information, data or credit.

To communicate with the payor it may include an output device. It may include two, or more, output devices. The two, or more, output devices may include, at least two of: a visual display, an audio output device, a printer; an output port for enabling the transfer of information to a computer-readable media device and/or a card device.

There may be a vault to store, at least one of, cash, checks and/or credit items, as well as, a housing to enclose and protect the apparatus.

To process the transaction, there may be a processor module configured to instruct the video display, audio output device or printer, to present selectable bill payment options to the payor, said selectable bill payment options comprising, pay by cash, by check, or checks, credit items, by electronic transfer or advance of funds from a source internal or external to the payor's financial institution. The processor module may be further configured to electronically process information associated with, at least one of, the payor, payee, of at least one of, the received deposit, transfer and/or verification of the payor's existing account, and/or accounts, balances, approval of the transaction, or information pertinent to the transaction.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows apparatus that may be used in accordance with the principles of the invention;

FIG. 2 shows an apparatus for use according to the principles of the invention;

FIG. 3 shows a schematic diagram of another apparatus for use according to the principles of the invention;

FIG. 4 shows a schematic diagram of hardware apparatus for use according to the principles of the invention;

FIG. 5 shows a schematic diagram of a network for use according to the principles of the invention.

FIG. 6 shows an illustrative flow diagram of an embodiment of payment action.

### DETAILED DESCRIPTION OF THE DISCLOSURE

This embodiment preferably includes an apparatus, a system and/or a method wherein an electronic, self-service apparatus, e.g., an automated teller machine (“ATM”) enables a payor to pay a bill. (If the payor is not a customer of the financial institution whose ATM is to be used, nor of any collaborating financial institution, he may make arrangements with the ATM's financial institution to secure access privileges.) Specifically, the payor selects a method from a choice of options that provide the financial resources to pay the bill. The choices include using cash deposited at the apparatus. The choices may also include a combination of, cash, a check, or other suitable credit item, e.g., credit slip, coupon, money order, credit card, debit card, deposited or read at the apparatus, the payor's existing account, or accounts, the payor's account, or accounts supplemented by one or more of, a deposit, a transfer, an advance of funds from a source internal or external to the payor's financial institution. The non-cash credit items may also be entered remotely from the ATM by a suitable input device. The payee may be a merchant, vendor, service provider, or other suitable supplier of goods, services, information, data, or credit, financial institution, or any other entity.

The apparatus may include a processing unit, and an input module for receiving data entered by the payor at the apparatus. This data may be entered using various methods including, but not limited to, key strokes on a keyboard or keypad, the payor's physical interaction with a screen or touch pad, or any other suitable tactile device, optical character recognition (“OCR”) for handwriting, an optical scanner, or any other suitable optical device, the payor's voice interaction with the apparatus, computer-readable memory devices, computer-readable card devices, prerecorded card, contact, or contactless, integrated circuit card, or device, or prerecorded, computer-readable device.

A further embodiment of the invention provides for a payor with certain disabilities to communicate with the apparatus using a suitable non-tactile, non-visual, non-audio, electronic process of communication between the payor's central nervous system (“CNS”) and the apparatus, e.g., electrical impulses from the brain.

The payor is enabled to enter relevant information into the apparatus about the payee, such as the payee's name, address, phone number, fax number, internet/web address (user resource locator, “URL”), the payor's account number, or numbers, personal identification number (“PIN”) with the payee, or any other relevant information. This data entry may be repeated for additional payees or accounts.

The invention may enable the payor to enter the information at, or before, the time of payment from a remote input device, such as, but not limited to, a personal computer, a personal digital assistant device (“PDA”),a mobile telephone built on a mobile computing platform (“smartphone”), or a telephonic device. These remote devices may contain, or may be capable of acquiring such input and of transmitting such information. The information may include financial information such as remotely depositing a check or credit item.

The apparatus includes a receiver module configured for receiving cash, a check, or suitable credit items; an item-handling mechanism for determining the value and authenticity of these items and a modem to enable communication with the payor, who may be at a remote distance from the apparatus.

The apparatus has an output module that preferably enables communication between itself, the payor and the payee, using a visual display, audio module, printer, computer-readable media, card device, or any other suitable communication device, and is enabled to communicate with a remote payee and/or payor.

The apparatus also contains a vault, and its protective housing, to store the, cash, checks or credit items, as well as, a housing to enclose and protect the apparatus.

A processor module may be configured to instruct a display, or any other suitable communication device, to present selectable bill payment options, listed above, to the payor. The processor module may be further configured to electronically process information pertinent to the payor, payee and financial institution, the received deposit, transfer or verification of the payor's existing account balance and approval of the transaction, or any other information pertinent to the transaction.

The invention may further enable the payor to enter into the apparatus the option and information regarding the selection of a one-time or recurring payment for, at least one of, the relevant payees. It may send a notice to the payor, by e-mail, or phone, etc., to go to an ATM and put in cash.

The payor is also able to enter, at, or before, the time of payment, from a suitable input device at the apparatus, or from a suitable remote input device, the amount to be paid towards the bill or the amount or proportion of the bill to be paid from each of the financial resource methods described.

The invention may also enable the payor to enter, at, or before, the time of payment, from a suitable input device at the apparatus, or from a suitable remote input device, the amount or proportion to be paid using foreign currencies, credit items or accounts, in combination with, or in place of, the local currency, or in combination with other financial resources. Any exchange rates to be used may be made evident to the payor using a suitable method of communication availing the payor the option to accept or decline the use of some or all of foreign currencies or credit items.

The apparatus is preferably enabled to communicate with the payor, using, one or more of, suitable communication mode, any fee, or fees, to be charged for, one or more, of the services to be provided, and that fee, or fees, may be added to the sum of the transaction amounts, or paid separately, enabling the payor the option to accept or decline any of those services.

The invention is preferably enabled to communicate to the payor using one, or more, suitable modes of communication, directions to insert a appropriate amount of cash rounded to, one or more presented options of, the next highest currency denomination. The payor inserts the appropriate amount of cash, checks, or other suitable credit items, to be validated for their authenticity. The payor is apprised of the authenticity and sufficiency of funds available from the various financial resources available to pay the bill and fees. The apparatus communicates to the payor an option for simple or detailed confirmation and summary statements, subject to the payor's choice, of the deposit, transfer and payment transactions using the payor's choice of visual, audio, recorded, computer-readable or printed information. The payor is apprised of a surplus arising from a difference between the appropriate deposit and the final amount paid, including any fees, and requested to select from various choices of where to credit the surplus.

An embodiment of this invention involving communications between the payor, the ATM, the non-local financial institutions and the payee will be described. Once the payee has logged into the ATM, having entered the pertinent information about the payor and/or non-local financial institutions, the processor may communicate with the above payee, payor and/or financial institutions, receiving the account information from them and process the detailed transactions locally. At the completion of the transactions the results are reported back to all the relevant parties listed above and the relevant accounts updated. Should there be further information required, e.g., transferring from another non-local financial institution, communications may be established between the payor and these non-local financial institutions, in real time, as necessary.

Another embodiment involving the above communications may be that all steps of the transactions be handled at their respective, non-local financial institutions and the payee. More specifically, after logging in, the processor communicates with the payee, receiving the amount due, with the payor to relay that amount, to collect the cash and credit items, compare this sum against the amount due, settle the transaction and report to all parties, updating the relevant accounts. Should there be further information required, e.g., transferring from another non-local financial institution, communications may be established between the payor and these non-local financial institutions, in real time, as necessary.

An embodiment of the invention will be described. A payee wishes to pay a department store (“DS”) charge card bill and a utility bill. He has at his disposal cash in U.S. dollars (“$US”), a tax refund check in $US, a credit slip from that department store, a 10% off his next bill coupon for recommending a new patron to the utility provider (“UP”), a quantity of cash in Euros (“ [symbol] ”) and an international money order (“MO”) in [symbol] for a refund of value added tax (“VAT”).

To save time, from home he enters financial institution #1's (“FI#1”) web site to establish an electronic banking account associated with his account there for the department store. He had previously established one for his utility provider. Interacting with FI#1 from his smartphone, he establishes this account by entering its name, a nickname for the department store account, its address, phone and fax numbers, and establishes a PIN, in response to the bank's request. Once established, he scans in his tax refund check using his smartphone, to be applied towards his department store electronic banking account.

On a subsequent day, he arrives at an ATM, logs into his account at FI#1, using the ATM's keyboard to enter its name, his PIN by the keypad. From his electronic banking he selects his department store account. Since his department store bill varies monthly. He responds to the ATM prompt that this is a one-time transaction. Upon prompts he deposits his $US cash to the next greater US$ 5. From the scanner he scans in his department store credit slip He is apprised that the total of these, and the previously deposited check, are insufficient to cover the bill. He prepares to deposit the cash and MO in [symbol] and is apprised of the day's exchange rates for cash and MOs. The former being more than he is willing to accept, he decides to put the cash aside for another use, but deposits the MO. Again he is apprised that the total is insufficient so he requests and advance on his homeowner's loan at financial institution #2 (“FI#2”) to be transferred to his account at FI#1 and applied towards his department store slot. Now he is apprised that the total is $US 3.65 in excess. Reacting to a prompt he requests that the surplus be deposited in his FI#1 savings account. The complexity of this transaction causes him to request a detailed, printed record of the transaction.

Finished with his department store transactions, he now wants to pay his utility provider account. He selects this electronic banking slot and signs into it using an OCR handwriting recognition device. Once in, he chooses to transfer the exact amount from a savings account at FI#2, since he lacked sufficient funds in his FI#1 checking account. He is on the utility provider's budget plan therefore for eleven months the payments are identical. In response to a prompt he chooses an automatic recurring monthly payment. This transaction being less complex he only requests an entry on his monthly FI#1 statement.

A further embodiment of the invention provides for the payor to communicate with the apparatus using a suitable non-tactile, non-visual, non-audio, electronic process of communication between the payor's central nervous system (“CNS”) and the apparatus. As an expansion of the embodiment described above, consider a paraplegic payor, who is also encumbered with a speech impediment caused by a stroke. Should he not trust his caretaker, this payor may avail himself of the above embodiment of the invention, described above, for the steps he wishes to keep confidential.

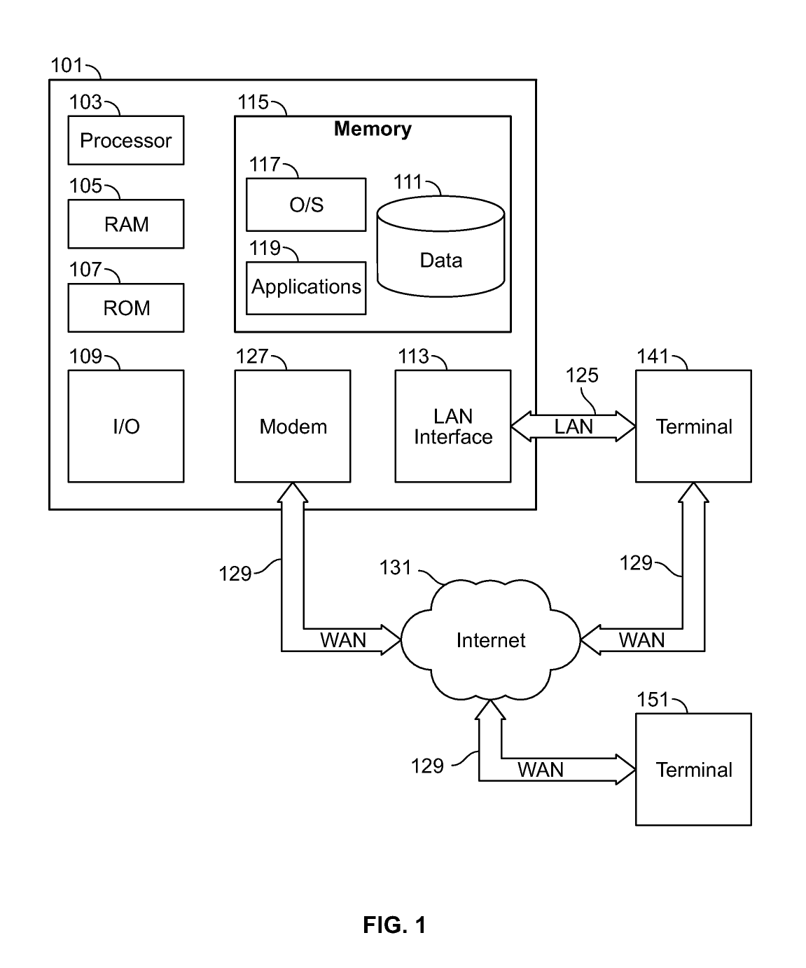

FIG. 1 is a block diagram that illustrates a generic computing device 101 (alternatively referred to herein as a “server”) that may be used according to an illustrative embodiment of the invention. The computer server 101 may have a processor 103 for controlling overall operation of the server and its associated components, including RAM 105, ROM 107, input/output module 109, and memory 125.

Input/output (“I/O”) module 109 may include, at least one of the following: a keyboard, keypad, touch screen, and/or stylus, optical scanning device, optical character recognition device (for handwriting), voice recognition device through which a user of device 101 may provide input, and may also include one or more of a speaker for providing audio output and a video display device for providing textual, audiovisual and/or graphical output, and/or a printer. Software may be stored within memory 125 and/or storage to provide instructions to processor 103 for enabling server 101 to perform various functions. For example, memory 125 may store software used by server 101, such as an operating system 117, application programs 119, and an associated database 121. Alternatively, some or all of server 101 computer executable instructions may be embodied in hardware or firmware (not shown).

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 123. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

Terminal 151 and/or 141 may be portable devices such as a laptop, smart phone, Blackberry™, or any other suitable device for storing, transmitting and/or transporting relevant information.

Any information described above in connection with database 121, and any other suitable information, may be stored in memory 125.

One or more of applications 119 may include one or more algorithms that may be used to settle accounts, pay bills and/or for any other suitable application.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

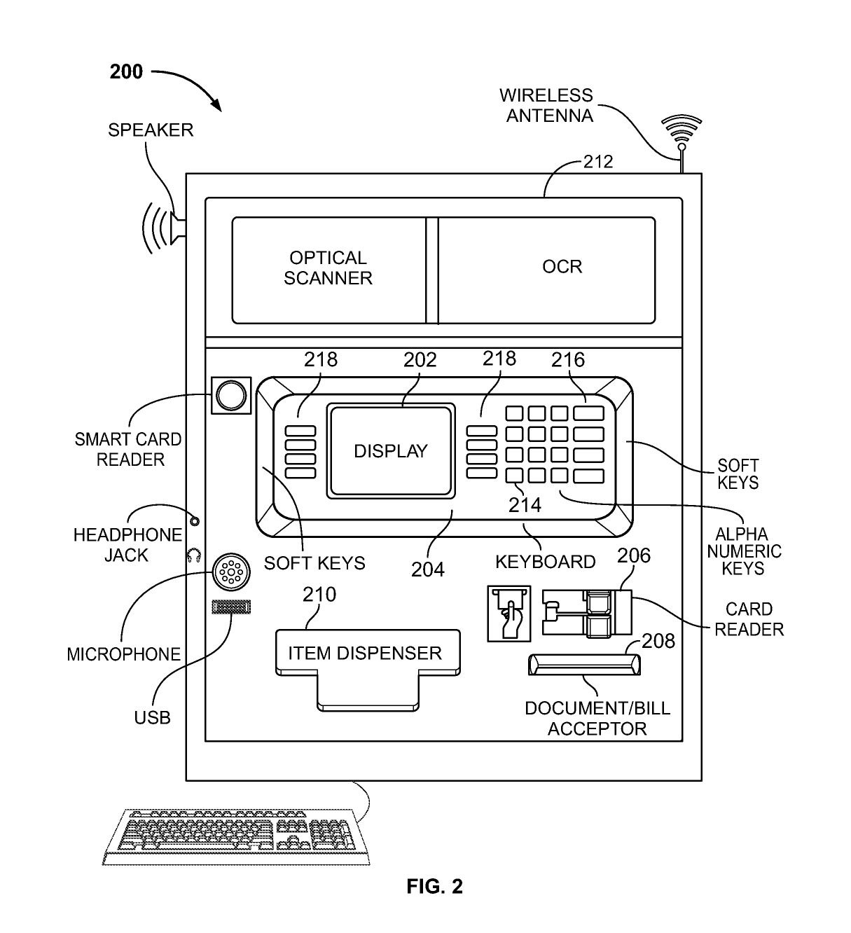

FIG. 2 shows illustrative self-service device 200, which may be an ATM. Self-service device 200 may include, one or more of, the following: display monitor 202, keypad 204, keyboard, touchpad, card reader port 206, document acceptor 208, cash acceptor, item dispenser 210, smart card reader USB port, microphone, headphone jack and/or speaker, optical scanner and optical character recognition device 212.

Monitor 202 may exchange visual information with a user. Keypad 204 may include alphanumeric keys 214 and keyboard for the user to enter numerical and textual data. Keypad 204 may include control keys 216. In some embodiments, control keys 216 may be used to communicate control information, such as instructions, to self-service device 200. Keypad 204 may include soft keys. Soft keys 218 may have functions that are dictated by programming and are presented to the customer using information that may be displayed on monitor 202.

Card reader port 206 may be the front end of any suitable card reader. The card reader may read magnetically encoded information on transaction instruments such as bank cards. In some embodiments, self-service device 200 may include a smart card reader, a wireless transceiver or any other suitable interface for exchanging transaction information with a transaction instrument. The transaction instrument may be a chip, an RFID tag, a smart card, a PDA, a telephone or any other suitable device.

In some embodiments, self-service device 200 may include a biometric sensor (not shown). The biometric sensor may identify a customer based on a feature, such as an anatomical feature, of the customer. For example, the biometric sensor may be configured to identify the customer based on all or part of a face, a fingerprint, an iris, a retina, a hand or any other suitable anatomical feature. The biometric sensor may identify the customer based on a behavioral feature such as a signature, a voice, a gait or any other suitable behavioral feature.

Document acceptor 208 may accept any suitable documents. For example, document acceptor 208 may accept envelopes, deposit forms, bills, checks or any other suitable documents. In some embodiments, document acceptor 208 may feed into a scanner that digitizes the documents for image-based transaction processing.

Item dispenser 210 may dispense items. For example, item dispenser 210 may dispense cash.

Security screen 212 may visually screen a surveillance device (not shown). The surveillance device may provide video information about individuals that are present near the self-service device and the conditions there.

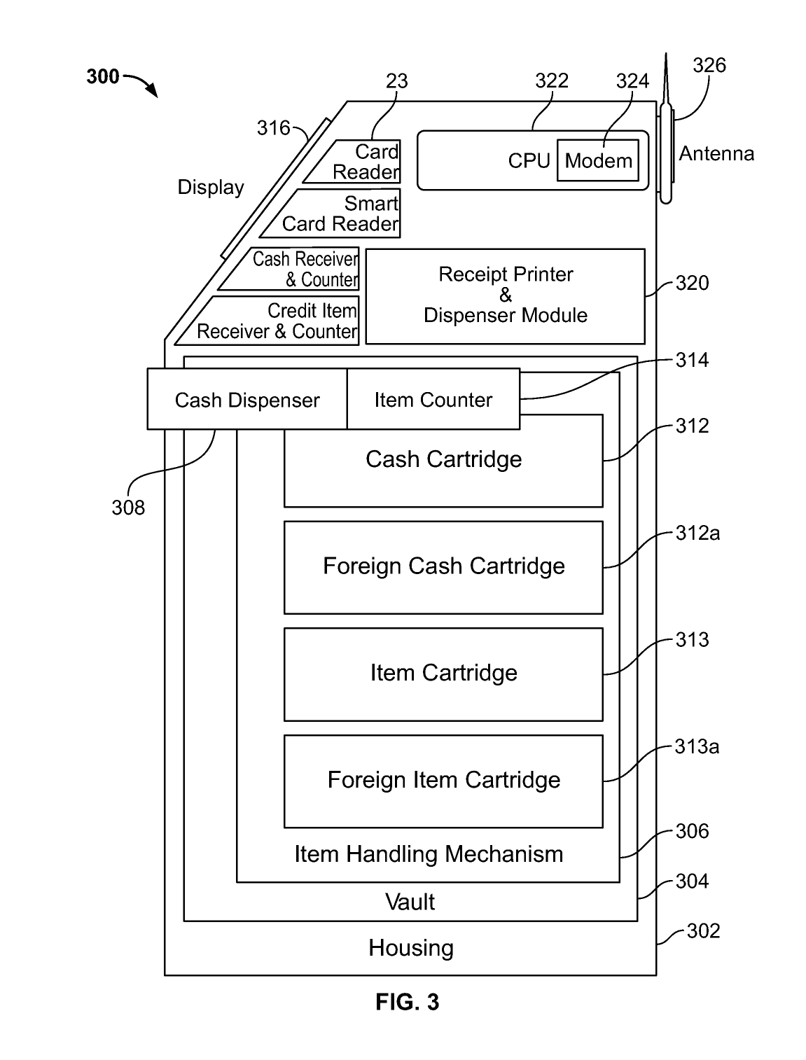

FIG. 3 shows illustrative self-service device 300. Self-service device 300 may have one or more of the features of self-service device 200 (shown in FIG. 2). Self-service device 300 may include housing 302. Self-service device 300 may include vault 304. Vault 304 may contain items (not shown). Item handling mechanism 306 may be present in vault 304. Item handling mechanism 306 may store, arrange, dispense and/or otherwise handle items for dispensing from self-service device 200. For example, item handling mechanism 306 may include conveyors (not shown) for positioning and repositioning items for dispensing by dispenser 308 through item port 310. Items (not shown) in item handling mechanism 306 may be contained in item cartridges 312. For example, when the items are bills, item cartridges 312 may be cash cartridges.

Item handling mechanism 306 may include item counter 314. Item counter 314 may count items prior to dispensing by dispenser 308.

Self-service device 300 may include LCD display 316 and a keypad (not shown) for customer interaction. Card reader 318 may be present for receiving transaction information from the customer via a suitable transaction instrument. Self-service device 300 may include receipt printer and dispenser module 320. Receipt printer and dispenser module 320 may provide the customer with a record of a transaction. CPU 320 may control customer I/O, dispensing processes, include initialization, actuation, dispensing and any other suitable processes, receipt printing and dispensing, transaction channel communications and any other suitable processes. The transaction channel communications may be performed using modem 324, which may be any suitable communication device. Modem 324 may communicate with a local or regional network router (not shown). Service monitor 326 may be provided for a service technician to exchange information and instructions with CPU 322.

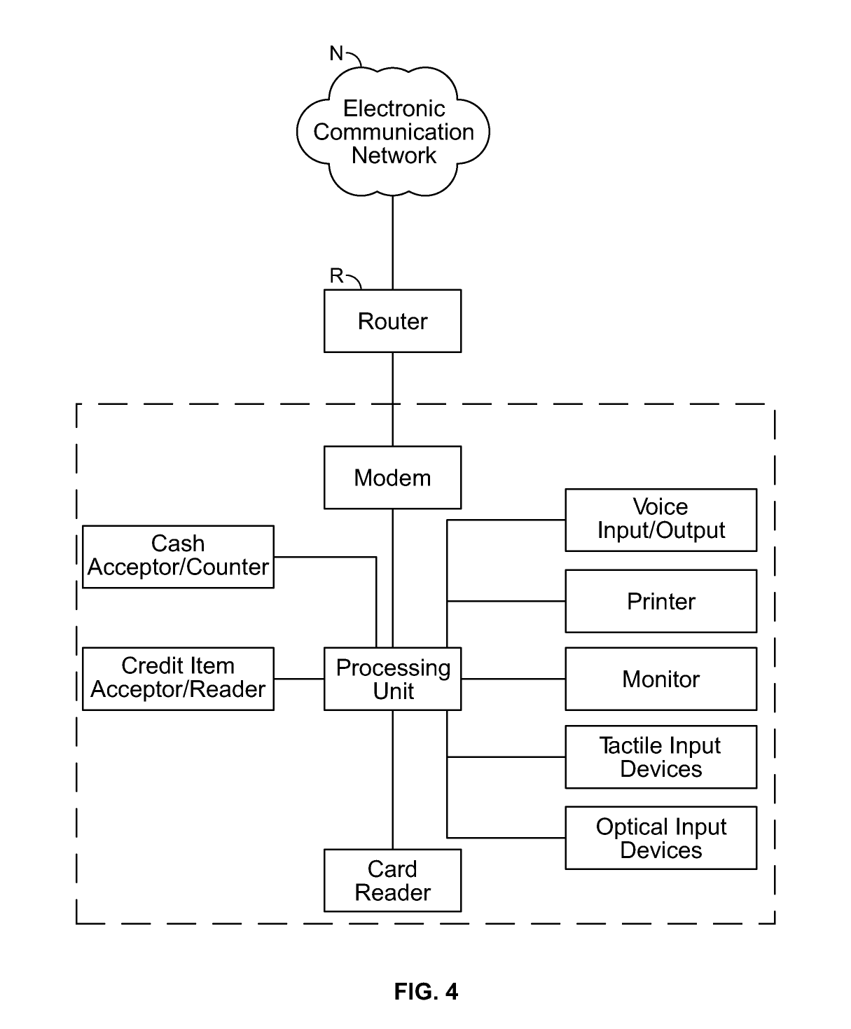

FIG. 4 shows control system 400 for controlling a self-service device such as 300 (shown in FIG. 3). System 400 is controlled by CPU 402. CPU 402 exchanges transaction information with electronic communication network N via modem 404, which is in communication with router R. CPU 402 may receive transaction information from a customer via monitor 406, keypad 408, card reader 410 and deposit acceptor 412. CPU 402 may dispense bills through bill dispenser 414.

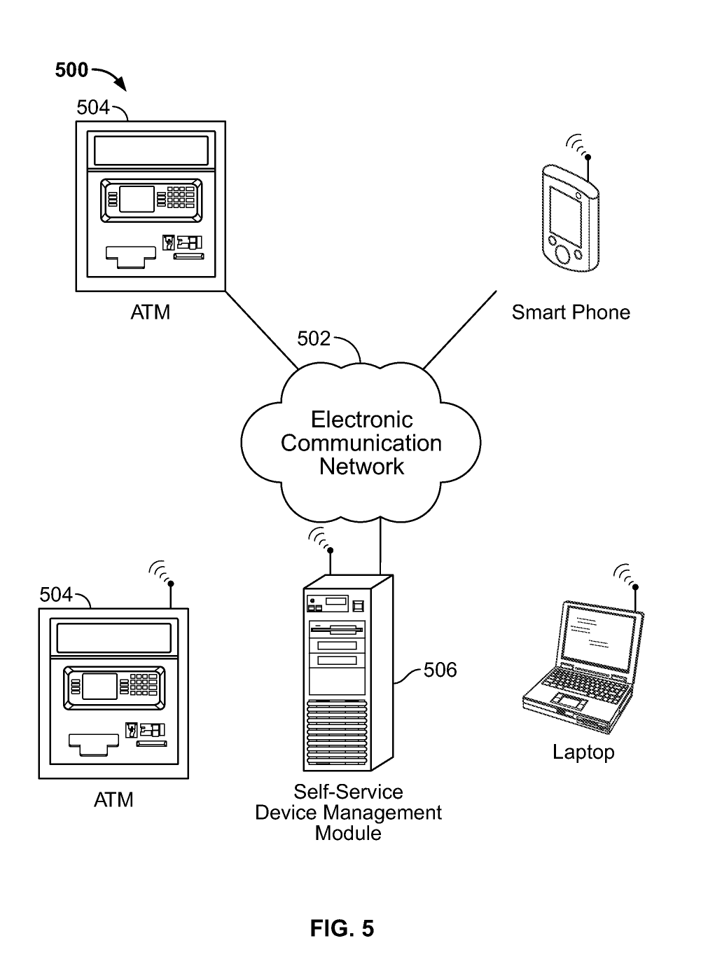

FIG. 5 shows illustrative transaction information network 500. Transaction information network 500 may include electronic communication network 502. Network 502 may be in part a LAN or WLAN, a WAN or WLAN or any other suitable network. Network 502 or portions thereof may be cabled, wired, optical fibered or wireless.

Self-service devices such as ATMs 504 may communicate via electronic communication network 502 with self-service device management module 506. Self-service device management module 506 may include one or more devices shown in FIG. 1. A remote user may use self-service device management module 506 to monitor, control, reset and/or intervene in one or more processes of ATMs 504.

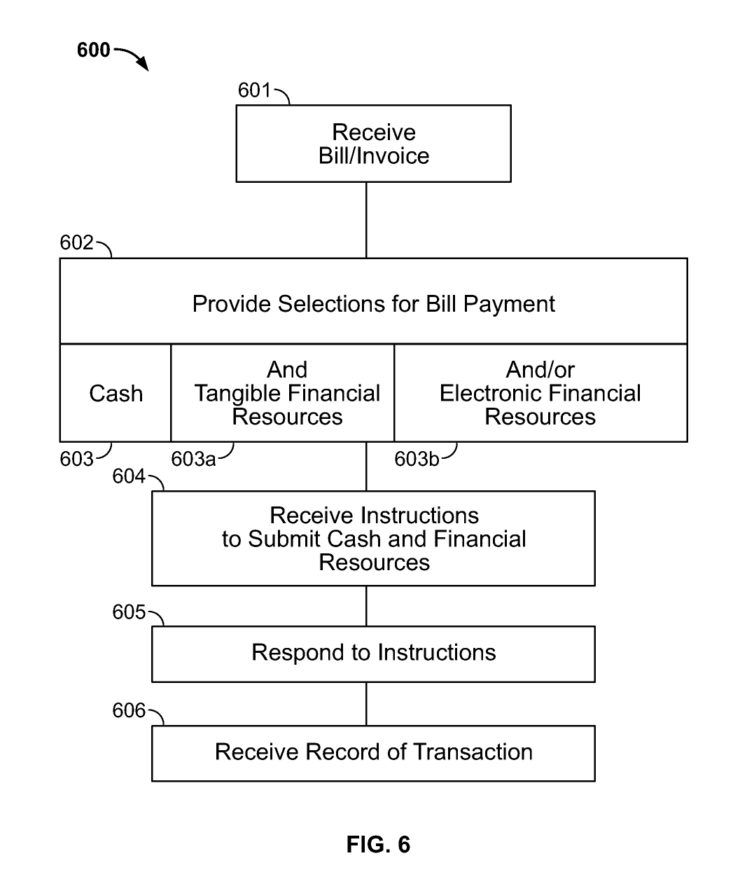

FIG. 6 shows an illustrative flow diagram of an embodiment of payment action 600. Box 601 shows receiving a bill or invoice and/or receiving a designation of a particular bill or invoice in, for example, input on an online banking portal or on an ATM display. Such receiving may include receiving the particulars relating to the bill or invoice. Such particulars may include the payee and payor information; the amount due information; the total balance information and other suitable information.

Box 602 shows providing selections for bill payment. Such selections may include cash bill payment 602, tangible financial resources bill payment 603a and/or electronic financial resources bill payment 603b.

Box 604 shows receiving instructions to submit cash and/or financial resources in payment of the bill or invoice. Box 605 shows responding to the instructions. Box 606 shows receiving a record of a transaction consummated based on the response to the instructions.

As will be appreciated by one of skill in the art, the invention described herein may be embodied in whole or in part as a method, a data processing system, or a computer program product. Accordingly, the invention may take the form of an entirely hardware embodiment or an embodiment combining software, hardware and any other suitable approach or apparatus.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, flash devices and/or any combination thereof. In addition, various signals representing data or events as described herein may be transferred between a source and a destination in the form of electromagnetic waves traveling through signal-conducting media such as metal wires, optical fibers, and/or wireless transmission media, e.g., air and/or space.

Data may move between various entities in any of the embodiments of the invention via electronic transmission or manual means. Electronic transmission may utilize email, SMS or any other suitable method. Manual exchange may utilize floppy disks, USB drives, CDs, DVDs or any other suitable mechanism.

Thus, apparatus and methods that provide navigation logic construct(s) for retirement outcome framework(s) are provided.

Persons skilled in the art will appreciate that the present invention can be practiced by other than the described embodiments, which are presented for purposes of illustration rather than of limitation, and that the present invention is limited only by the claims that follow.

1. An electronic self-service apparatus for enabling a payor to pay a domestic, or foreign, pre-existing bill or invoice, hereinafter “bill”, using cash in combination with a bank account balance,
the apparatus comprising:
a processing unit;
an input module for receiving input data entered by the payor at the apparatus, wherein said input data comprises, at least one of:
a tactile input,
an optical input,
a voice input, or
a pre-recorded, computer-readable media and/or card device input;
at least one receiver module configured for receiving, counting and validating the cash;
at least one item-handling mechanism for accepting and/or storing the cash;
a modem for enabling communication between, at least two of, the payor, a payee, a financial institution, and the apparatus;
an output module for enabling the entry of information to a computer-readable media device;
a vault to store the cash;
a housing to enclose and protect the apparatus; and
a processor module configured to instruct, at least one of, a video display, an audio output device, and/or a printer to present selectable bill payment options to the payor, said selectable bill payment options comprising pay by cash in combination with the bank account balance;
wherein the processor module is further configured to electronically process information associated with, at least one of, the payor, a payee, and a financial institution, said information comprising:
a verification of an existing bank account balance accessible to the payor; and
at least one of
a received deposit,
a transfer,
an approval of a transaction, and/or
information detailing a transaction.

2. The apparatus of claim 1 wherein the payor is enabled to select from a plurality of options that provide funds to pay said bill by a combination of cash, the bank account balance and at least one of:
a check; and
a credit item deposited at the apparatus.

3. The apparatus of claim 1 wherein the payor enters, at, or remotely from, said apparatus, at or before, the time of payment, information from a remote input device said remote input device comprising at least one of:
a personal computer,
a personal digital assistant device (“PDA”),
a mobile telephone built on a mobile computing platform (“smartphone”),
a telephonic device,
wherein the aforementioned remote devices are capable of reading, transmitting and/or receiving information and/or data from one, or more, of:
a tactile device,
an optical device,
a voice interactive device, and
a prerecorded, computer-readable media card or device.

4. The apparatus of claim 1 wherein the payor enters:
first information into the apparatus, locally or remotely, about a payee, or payees, the first information comprising, at least one of the payee's name, address, phone number, fax number, internet/web address (user resource locator, “URL”), and the payor's bank account number;
second information regarding a selection of a one-time or recurring payment for the payee;
a first proportion of the bill to be paid by cash;
a second proportion of the bill to be paid by a check;
a third proportion of the bill to be paid by a credit item; and
a fourth proportion of the bill to be paid from the bank account balance.

5. The apparatus of claim 1 wherein:
the cash comprises a foreign currency and is deposited at the apparatus, at or before the time of the payment request;
the bank account balance comprises:
the payor's existing foreign currency bank account, or the payor's accessible foreign bank account;
the payor's foreign currency bank account, or the payor's accessible foreign bank account, supplemented by, one or more of, a deposit, a transfer, an advance, of foreign currency funds from a foreign financial resource internal, or external to the payor's financial institution;
the input module is configured to receive, from the payor, an amount foreign currency in combination with an amount of local currency;
the processor module is configured to determine one, or more, exchange rates to be used; and
utilizing, one or more of, visual, audio, recorded, printed information, enabling the payor to accept or decline the use of, one or more of foreign currencies, checks or credit items.

6. The apparatus of claim 1 where any fee charged for, one or more, of services provided is added to a sum of a transaction amount, or paid separately, is made evident to the payor as, one or more of, visual, audio, recorded, printed information, enabling the payor with an option to accept or decline said service or services.

7. The apparatus of claim 1:
wherein, in response to receiving a bill amount, the payor is directed to insert an amount of cash rounded to a next highest multiple of available currency denominations; and
wherein:
the payor inserts the amount of cash to be validated for authenticity and value; and
the payor is apprised of the authenticity and sufficiency of the inserted cash.

8. The apparatus of claim 1 wherein the payor is communicated, subject to the payor's choice, a simple or detailed confirmation and summary statement, of at least one of:
a deposit,
a transfer and
a payment transaction in, one or more of, visual, audio, recorded, computer-readable or printed information modalities.

9. The apparatus of claim 1 wherein:
the payor is apprised of a surplus arising from a difference between a total value of cash accepted by the item-handling mechanism and a portion of the bill, including any fees, to be paid using the total value of cash; and
said surplus is added to the bank account balance.

10. The apparatus of claim 1 where the payor communicates with the apparatus, locally or remotely, using a suitable non-tactile, non-visual, non-audio, electronic process of communication between the payor's central nervous system (“CNS”) and the apparatus.

11. A system employing an electronic self-service apparatus that enables a payor to pay a bill, using cash in combination with a bank account balance of the payor, the system comprising:
a processing unit;
an input module for receiving data entered by the payor wherein said data input comprises, at least one of: a tactile input, an optical input, a voice input and a pre-recorded, computer-readable media input;
at least one receiver module configured for receiving, counting and validating the cash;
at least one item-handling mechanism for accepting and/or storing the cash;
a modem for enabling communication between, at least two of: the payor, a payee, a financial institution and the apparatus;
a communication module comprising at least two of: a visual display, an audio output module and a printer;
an output module for enabling the entry of information to a computer-readable media device;
a vault to store the cash;
a housing to enclose and protect the apparatus;
a processor module configured to instruct the communication module to:
present a bill payment option comprising pay by cash in combination with the bank account balance of the payor;
in response to selection of the bill payment option, a prompt for the payor to enter:
a first amount of the bill to be paid from the cash; and
a second amount of the bill to be paid from the bank account balance;
evaluate the authenticity and sufficiency of funds available from the inserted cash available to pay said bill;
apprise the payor of a surplus resulting from a difference between the first amount of the bill to be paid from the cash and a deposited amount of cash accepted by the item-handling mechanism;
identify a plurality of bank accounts where to credit the surplus; and
credit the surplus to at least one of the plurality of bank accounts;
wherein the processor module is further configured to electronically process information associated with, at least one of, the payor, a payee, a financial institution, said information comprising, at least one of, a received deposit, a transfer, a verification of an existing account balance accessible by the payor, an approval of the transaction, and information associated with the transaction.

12. The system of claim 11 wherein the payor is enabled to select an option that provides funds to pay said bill by:
cash deposited at the apparatus, at or before, the time of a payment request;
a check;
a credit item, deposited at the apparatus; and
the bank account balance.

13. The system of claim 11:
wherein the payor transmits to the system, at, or remotely from, said apparatus, at or before, the time of payment of the bill data from a remote input device;
wherein said remote input device comprises at least one of:
a personal computer,
a PDA,
a smartphone,
a telephonic device; and
wherein the aforementioned remote devices are capable of reading, transmitting and/or receiving the data from one, or more, of:
a tactile device,
an optical device,
a voice interactive device, and
a pre-recorded, computer-readable media card or device.

14. The system of claim 11 wherein the payor enters, at said apparatus, at or before, the time of payment, the information from an input device comprising, at least one of:
a tactile device,
an optical device,
a voice interactive device,
a computer-readable media device,
a prerecorded, computer-readable device or card containing said information; and
a remote input device;
wherein said remote input device, is capable of acquiring, transmitting and/or receiving information.

15. The system of claim 11 wherein the payor enters relevant information into the apparatus about the payee, or payees, comprising:
at least one of, the payee's name, address, phone number, fax number, URL, the payor's account number, or numbers;
a selection of a one-time or recurring payment for, at least one of, a relevant payee;
the first amount of the bill to be paid from cash; and
the second amount of the bill to be paid from the bank account balance.

16. The system of claim 11 wherein:
the cash comprises cash in a foreign currency, or currencies, deposited at the apparatus, at or before the time of the payment request;
the bank account balance comprises:
funds corresponding to a check, or credit item, in a foreign currency, or currencies, deposited at the apparatus, or from a remote input device;
funds corresponding to a transfer communicated to the apparatus, or from a remote input device, from the payor's existing foreign currency bank account, or accessible bank account; or
the payor's foreign currency bank account balance, or accessible foreign bank account balance, supplemented by funds corresponding to one or more of, a deposit, a transfer, an advance, of foreign currency funds from a foreign financial resource, internal or external, to the payor's financial institution;
the payor enters, locally or remotely, an amount or proportion consisting of:
one, or more, foreign currencies; and
a local currency; and
the payor is apprised of, one or more, exchange rates utilizing, one or more of, visual, audio, recorded, printed information, enabling the payor with an option to accept or decline the use of two, or more, of foreign currencies or credit items.

17. The system of claim 11 where a fee, or fees, to be charged for, one or more services to be provided by the system, are added to the sum of the transaction amounts, or paid separately, and are made evident to the payor as, one or more of, visual, audio, recorded, printed information, enabling the payor with an option to accept or decline said service or services.

18. The system of claim 11:
wherein the payor is directed to insert a appropriate amount of cash rounded to a next highest multiple of available currency denominations;
wherein the payor inserts the appropriate amount of cash to be validated for authenticity and value and is subsequently apprised of the authenticity and sufficiency of funds available from the inserted cash available to pay said bill and fees.

19. The system of claim 11 wherein the payor is communicated a simple or detailed confirmation and summary statement, subject to the payor's choice, of at least one of: the deposit, transfer and/or payment transactions in, one or more of, a visual, an audio, a recorded, computer-readable or printed information modality.

20. (canceled)

21. The system of claim 11 where the payor communicates with the apparatus, locally or remotely, using a suitable non-tactile, non-visual, non-audio, electronic process of communication between the payor's central nervous system (“CNS”) and the apparatus.

22. A method employing an electronic self-service apparatus that enables a payor to pay a bill, using cash in combination with a bank account balance, the apparatus comprising:
an input module for receiving data entered by the payor at the apparatus, wherein said data input comprises, at least one of, a module for receiving:
a tactile input,
an optical input,
a voice input, and
a pre-recorded, computer-readable media or card device input;
an item-handling mechanism for accepting the cash, checks and/or credit items;
a modem for enabling communication between, at least two of, the payor, and a payee, a financial institution, or institutions and the apparatus;
at least two of a visual display, an audio output module, and a printer;
an output module for enabling the entry of information to a computer-readable media device;
a vault to store the cash;
a housing to enclose and protect the apparatus; and
a processor module configured to execute machine readable instructions that:
instruct a video display, an audio output device and/or a printer, to present selectable bill payment options to the payor, said selectable bill payment options comprising using the cash in combination with the bank account balance;
electronically process information associated with, at least one of, the payor, a payee, and at least one of:
a received deposit,
a transfer,
a verification of the payor's existing account, and/or accessible accounts,
account balance or balances,
approval of the transaction, and
information associated with the transaction;
require the payor to enter a first proportion of the bill to be paid from the cash and a second proportion of the bill to be paid from the bank account balance, a sum of the first proportion and the second proportion equals an amount due of the bill;
direct the payor to insert into the apparatus a deposit amount of cash rounded to a next highest multiple of available currency denominations, and
apprise the payor of an authenticity and a sufficiency of funds available to pay said bill.

23. (canceled)

24. The method of claim 22 wherein the payor enters, at, or remotely from, said apparatus, at or before the time of payment, the information from a remote input device capable of acquiring, transmitting and/or receiving information from one, or more, of:
a tactile device,
an optical device,
a voice interactive device,
a prerecorded, computer-readable media device, or card.

25. (canceled)

26. The method of claim 22 wherein:
the cash comprises cash in a foreign currency;
the payor enters, locally or remotely, an amount or proportion consisting of one, or more, foreign currencies, in combination with, or instead of, a local currency; and
the payor is apprised of one, or more, exchange rates, or rates, utilizing, one or more of, visual, audio, recorded, printed information, enabling the payor the option to accept or decline the use of one, or more, of foreign currencies or credit items.

27. The method of claim 22 where any fee, or fees, to be charged for, one or more services to be provided, is made evident to the payor as, one or more of, visual, audio, recorded, printed information, enabling the payor with the option to accept or decline said service or services.

28. (canceled)

29. The method of claim 22 wherein the payor is communicated a simple or detailed confirmation and summary statement, subject to the payor's choice, of at least one of the deposit, transfer and payment transactions as, one or more of, visual, audio, recorded, computer-readable or printed information modality.

30. The method of claim 22 wherein:
the payor is apprised of a surplus arising from a difference between the deposit amount and the first proportion of the bill to be paid using the cash, including any fees; and
the payor is requested to select from a plurality of bank account choices where to credit the surplus.

31. The method of claim 22 where the payor communicates with the apparatus, locally or remotely, using a non-tactile, non-visual, non-audio, electronic process of communication between the payor's central nervous system (“CNS”) and the apparatus.
